(19) United States
(12) Patent Application Publication
(10) Pub. No.: US 2025/0254028 A1
(43) Pub. Date: Aug. 7, 2025

(54) Authentication System and Method Using Browser Extension

(71) Applicant: Traitware, Inc., Reno, NV (US)

(72) Inventors: Christopher Canfield, Santa Clarita, CA (US); Carson Hawley, Hutsonville, KY (US); Spencer Balogh, Chicago, IL (US); A Heath Spencer, Truckee, CA (US); Herbert W. Spencer, III, Grass Valley, CA (US)

(21) Appl. No.: 19/044,512

(22) Filed: Feb. 3, 2025

Related U.S. Application Data
(60) Provisional application No. 63/549,481, filed on Feb. 3, 2024.

(51) Int. Cl. H04L 9/08; G06F 21/36; H04L 9/32

(52) U.S. Cl. CPC H04L 9/0825; G06F 21/36; H04L 9/3226

(57) ABSTRACT

Systems and methods include features to eliminate or reduce man-in-the middle vulnerability of an authentication process. The systems and methods to login to a protected resource may require two registered devices in the system before the method to authenticate a user is performed. The systems and methods may include any combination of: registration of a browser extension; allow regular login directly to a provider if the extension is not installed, but requiring use of a login through the extension if the extension is installed; require use of an extension for an application, customer, account, or other criteria and not permit login without the extension; allow direct login if authorized through a separate application (whether or not login through a browser is required through a different device); permit administrative approval of an extension and granular controls of the systems and methods described herein permitting selection of features and requirements.

### BACKGROUND

Exemplary systems and methods for multi-factor authentication (MFA) such as those already employed by applicant may provide a very secure authentication platform. But more can be done to make it even more secure. One known vulnerability of current MFA systems and methods is that a bad actor could create a duplicate website or authentication website that, though having a different domain name, could attempt to trick a user into logging into it by looking very similar to a legitimate login site. Through a phishing attack or social engineering, a bad actor could trick a user into clicking on a false authentication link to a false authentication platform that was duplicating a legitimate authentication platform login. Commonly referred to as a man-in-the-middle attack, if a user attempts to complete the login process on the malicious website, a bad actor could intercept the login assertion or session and gain access to the protected resource.

### SUMMARY

Embodiments of the present disclosure relate to the computer security field, specifically to an authentication method using a browser extension on a browser of a first device and a second device for secure user access.

Embodiments of the present disclosure may provide features to eliminate or reduce man-in-the middle vulnerability. In an exemplary embodiment, the systems and methods to login to a protected resource may require two registered devices in the system before the method to authenticate a user is performed. Users would have a first device, being a PC or tablet with a web browser that has an authentication browser extension added, and a second device with a previously registered token, such as a mobile device with an application using an authentication protocol. The browser extension may be registered to the authentication server on behalf of the user. Using the registered mobile authenticator application and the registered browser authentication extension together during a login attempt greatly reduces the likelihood that a phishing attack will be successful.

In one embodiment, a browser extension is added to a browser, and a user is registered to that extension by using a multi-factor authenticator application previously associated with the user on an authentication server. The browser extension may create a public/private key pair and associate the public key with the user on an authentication server. The user not only has the private key stored in their mobile device for their authenticator application, but also a key pair that is now associated with the extension authenticator. The registered browser extension may be configured to only serve the contents needed for a login attempt if the browser is on an approved login URL, and otherwise will not serve content needed for a login attempt. Moreover, in optional configurations, only the user registered to the browser extension may initiate a login and any other users would be prevented from initiating a login. Using the registered mobile authenticator application and the registered browser authentication extension together during a login attempt greatly reduces the likelihood of a phishing attack being successful.

To prevent the login, the system may not initiate a login attempt or the prevented step from occurring if the system requirements such as the previous registration, association, or authentication has not been performed satisfactorily or otherwise met the requirements.

In one embodiment, a user may authenticate to their previously registered mobile authentication application and scan a quick response (QR) code presented by a browser authentication extension to register the user with the authentication extension. The user may also be required to enter a PIN (a unique identifier) presented by the authentication extension into their mobile authentication application after scanning the QR code to ensure the user intends to scan the QR. If the authentication server successfully validates the registration request, the user is registered with the authentication extension.

In another embodiment, a user may visit a protected resource and be redirected to a login page. Having a previously installed browser authentication extension previously registered to a user, the extension may override the content of the login page, requiring the user to log in through the extension. The user may authenticate to their mobile authentication application and scan a QR code representing a login attempt that the extension retrieves from the authentication server and presents as a QR code. The mobile app scans the QR code with its camera and sends the contents of the QR code to an authentication server and the extension polls the authentication server for login approval. If the login is approved by the authentication server, the extension requests the identity payload from the authentication server and, if the identity payload is received, redirects to the protected resource, where the identity payload is used to log the user into the protected resource.

According to embodiments of the present disclosure, the user is first identity proofed. Identity proofing could be as simple as possession of the ability to receive an email at a specific email address or, for higher security, the identity proofing process can require the user be registered to physically meet with an administrator for an authentication server and present physical identification (ID) such as a driver license, passport and other identification documents. The process could require someone that personally knows them, identify them and verify that they are, who they say they are.

Once the user is identified, the user is registered to a device that can generate and store a public/private key pair set. This might be something such as a physical token like a Yubikey or a mobile device with an authentication application such as the authentication applications from the applicant on a user's mobile device. The physical possession of the device may be satisfactory, but the user may also or alternatively authenticate to the device either with a knowledge factor or biometric or with both. Other factors can also optionally be required in the registration of the device such as its geolocation or other identity factors that are stored on the device.

This first device is used as the user's authentication token and is used during the authentication process. Even having this registered device, the user could still be subject to a man in the middle attack that creates a false login site where the user can be phished attempting to access the false login site. This could allow a bad actor to achieve access to a secured resource such as a Google document, email or other resources such as a secured website.

This invention provides a means to prevent or reduce the success of a man-in-the-middle attack by having the user register an additional application, such as a browser extension, to an authentication server to which the first device is registered.

In an optional embodiment, the first device and extension application are registered to different servers. In this embodiment, the registration of the extension or second authentication application requires obtaining stored information from the second device through an application stored and executed on the second device and transferring that to the authentication server. The user first authenticates to the first device and uses it to connect to the authentication server. In an exemplary embodiment, the extension on the second device creates a public/private key pair that can be used as one identifying factor. The public key is transferred to the authentication server and the private key remains on the device. Other factors may optionally also be required to be stored on the device and transferred to the authentication server for identification. Once the application (app) or extension on the second device is registered it can then be used to interact with the authentication server to obtain a nonce that it can display or otherwise transmit to the second device which would be used to authenticate and start the authentication process to access secure resources through the second device.

In an optional embodiment, the user registered to the authentication extension must authenticate to a service provider through the extension using a first device registered to the same user. This prevents a user from sharing their screen and allowing a different user to scan the login QR code.

In an optional embodiment, the extension is publicly available on a browser store, such as the Firefox Add-On store and Chrome Web Store. In one embodiment, the extension may be digitally signed by the browser store where it is available. Availability on official browser stores and a digitally signed extension reduces the likelihood of a user installing a malicious extension.

### DRAWINGS

FIG. 1 illustrates an exemplary swim lane process diagram of a registration of a user to an authentication browser extension according to exemplary embodiments of the method and system described herein.

FIGS. 2A-2B illustrates an exemplary swim lane process diagram of a login of a user to a service provider using a registered authentication browser extension according to exemplary embodiments of the method and system described herein.

FIG. 3 illustrates an exemplary browser extension installed on a browser with the extension turned off.

FIG. 4 illustrates a service provider webpage with two login buttons in the upper right corner.

FIG. 5 illustrates a passwordless multi-factor authentication (MFA) login screen without an extension installed.

FIG. 6 illustrates a login screen when the extension is installed. As an example illustration, the upper right corner shows the extension present and the logo of the pinned extension.

FIG. 7 illustrates a pop-up window of the extension displaying a quick response (QR) code representing a login attempt which is scanned with an authenticator application using an account connected to the service being logged into.

FIG. 8 illustrates a user interface on the browser after a successful login resulting in an updated pop-up showing the user has logged in.

FIG. 9 illustrates an exemplary user interface after scanning the QR code with a registered authenticator app account from an account that is not registered to the browser extension, resulting in a failed login attempt being displayed.

FIG. 10 illustrates user interface of a browser providing a welcome screen displayed after an extension is installed and before a user is registered.

FIG. 11 illustrates a user interface of the browser after the selection to start the registration process having a pop-up with a registration QR code and digital pin. The pop-up may include icons such as the plus to add additional accounts, or the gear to enter an advanced or set up mode. Selecting the icon to add an account may update the pop-up with a new QR code and registration PIN.

FIG. 12 illustrates an exemplary mobile device screenshot displaying when a user has multiple accounts and a user may select an account from a list of accounts.

FIG. 13 illustrates an exemplary screenshot of the mobile application providing a QR scanning screen of an authenticated mobile authenticator application.

FIG. 14 illustrates an exemplary screen displayed on the mobile authentication application after scanning the QR code in the extension registration popup, where a field is presented for a user to manually enter the PIN displayed in the extension registration popup window.

FIG. 15 illustrates a user interface on the mobile application indicating the successful registration of the extension to the user account after entering the correct PIN.

FIG. 16 illustrates an exemplary browser extension user interface in which a user has multiple accounts registered to the extension to list the registered accounts and permit the user to select the account they intend to use for a login attempt before presenting the display of FIG. 11 to permit the user login.

FIG. 17 illustrates an exemplary successful login by a user into an account selected from a list of accounts in the authentication extension.

FIG. 18 illustrates an exemplary system diagram to implement the methods described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention and are not limiting of the present invention nor are they necessarily drawn to scale.

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

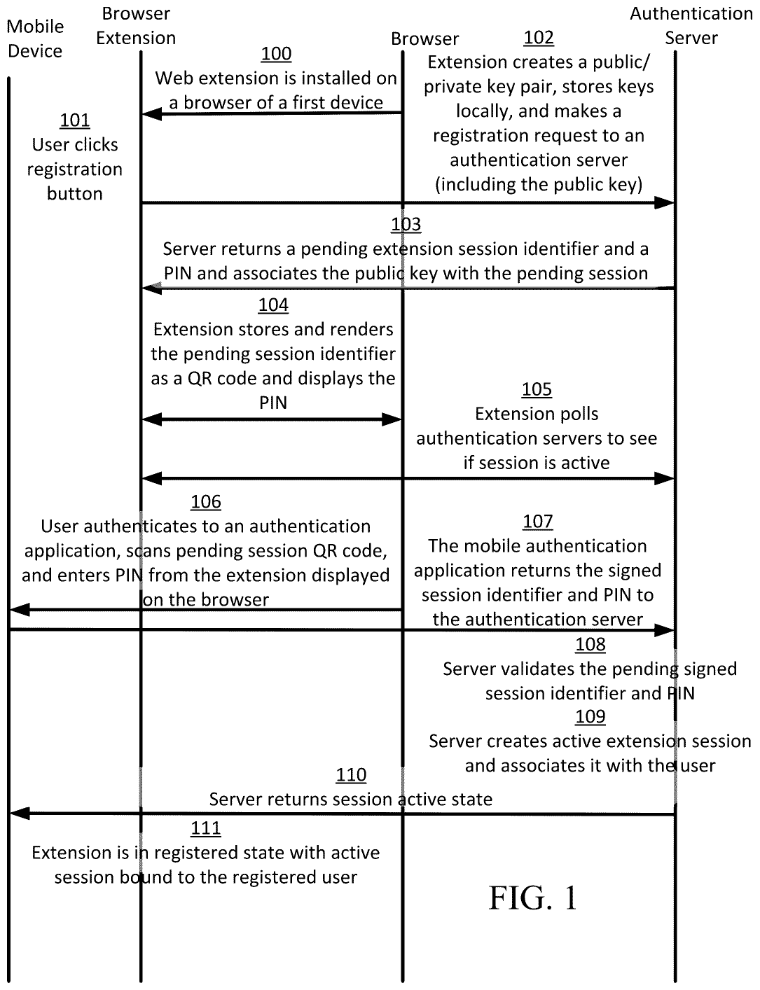

FIG. 1 illustrates an exemplary swim lane process diagram of a registration of a user to an authentication browser extension according to exemplary embodiments of the method and system described herein.

A browser extension is installed on a browser on a first device (100), such as a desktop computer. A user opens the extension and clicks a registration button (101).

The extension on the first device creates a public/private keypair, stores them locally, and makes a registration request to an authentication server, the request containing the public key of the created key pair (102).

The authentication server creates a pending extension session identifier and a PIN (personal identification number or other identifier unique to the user), associates it with the public key sent by the extension, and returns the pending session identifier and PIN to the extension (103).

The extension receives the pending session identifier and PIN, locally stores the pending session identifier, displays the pending session identifier as a quick response (QR) code, and displays the PIN numerically (104). The extension polls the authentication server to see if the pending session has become active (105). Although used herein as displaying the session identifier as QR code, other embodiments are also optional. For example, a session identification can be shown in which a user can manually enter into another device or other methods of transmission may also or alternatively be used besides visual, such as electronic through radio frequency, blue tooth or wifi.

On a second device, such as a mobile device, a user authenticates to an authentication application previously associated with an authentication server, scans the pending session QR code, and manually enters the PIN displayed in the extension. As explained above, although specific example of transmission of information is provided such as in the display of a QR code or manual entry of a PIN, other configurations are alternatively optional. For example, transmission may be automatic or manual such as in the transmission of information through camera image recognition, radio frequency transmission, blue tooth transmission, or wifi, or the transmission may be manual such as in the visual identification and entry of a alphanumeric code or in the capturing of an image with a camera or a combination thereof.

The mobile authentication application signs the session identifier and PIN with the mobile application's private key and sends the signed payload to the authentication server (107).

The authentication server validates the pending signed session identifier and PIN (108) and it creates an active extension session and associates it with the user whose device sent the signed session identifier and PIN (109). The server returns a session active state (110) to the extension which has been polling (105) to determine if the session has become active.

The extension receives the active session state from the authentication server and the extension changes to a registered state, where the now active session is bound to the registered user (111).

In one embodiment, multiple user accounts may be registered with the extension following the same registration process described herein.

In an alternate optional embodiment, registration may take place via Bluetooth or other known communication methods rather than using a QR code and PIN or by using any combination thereof.

In an alternate optional embodiment, the authentication server may restrict registration to specific browser types.

In an alternate optional embodiment, an administrator may be required to approve a registration request.

In an alternate optional embodiment, the public/private key pair may use elliptic-curve cryptography.

In an alternate optional embodiment, the JOSE framework may be used to send keys to and validate signatures on the authentication server, such as the extension sending the public keys in a JSON Web Key Set (JWKS) and the server validating a JSON Web Signature (JWS) for extension requests to the authentication server.

In an alternate optional embodiment, other asymmetric cryptography methods known in the art may be used.

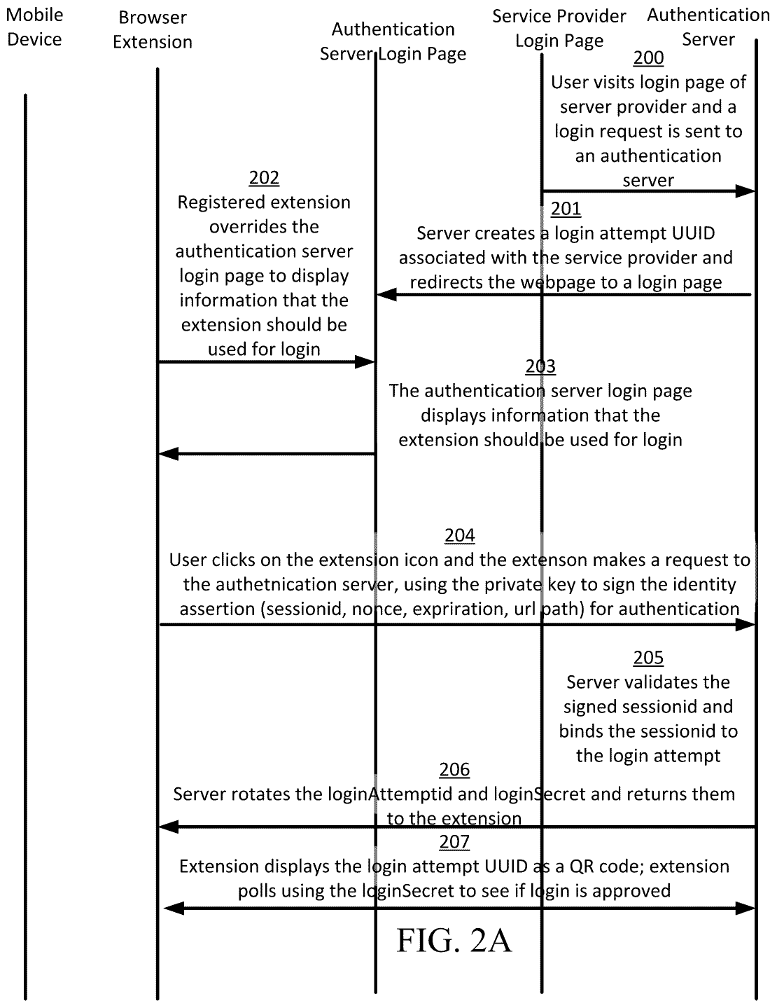

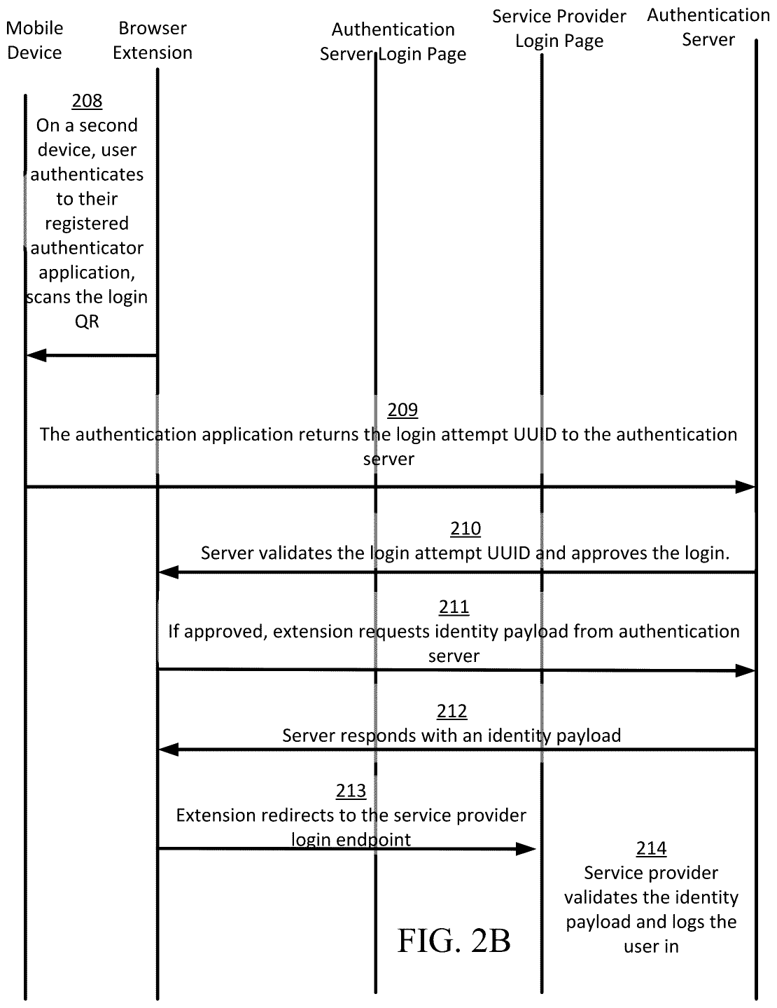

FIGS. 2A-2B illustrates an exemplary swim lane process diagram of a login of a user to a service provider using a registered authentication browser extension according to exemplary embodiments of the method and system described herein.

A user visits a login page of a service provider and a login request is sent to a server login endpoint (200).

In an alternate optional embodiment, the service provider is configured to send login requests to an authentication server using identity standards such as SAML or OpenID Connect.

The authentication server creates a login attempt universally unique identifier (UUID), associates it with the service provider, and the browser is redirected to a login page managed by the authentication server (201).

The registered authentication extension overrides the authentication server login page to display information that the extension should be used for login (202). In an alternate optional embodiment, the extension is configured to only allow login attempts to take place from predetermined URLs. These uniform resource locator (URL) s may optionally be hardcoded into the extension.

The authentication server login page displays information that the extension should be used for login (203).

A user clicks on the extension icon and the extension reads login parameters from the URL, such as the login attempt identification (UUID) and login secret. The extension makes a request to the authentication server, using the previously created and stored private key to sign the active extension sessionId, nonce URL path, and expiration time for validation by the authentication server.

The authentication server validates the signed sessionId, nonce, URL path, and expiration and binds the sessionId to the login attempt (205).

In an alternate optional embodiment, the authentication server may determine the user does not have access to the service provider resource associated with the login attempt UUID and may terminate the login attempt.

If the user does have access to the service provider resource, the server rotates the login attempt UUID and login secret and returns them to the extension (206). Here, rotates means to change the login UUID and login secret to new values, where the previous values are no longer able to be used in the process.

The extension displays the login attempt UUID as a QR code and begins to poll the authentication server to see if the login has been approved (207). Although a QR code is shown and described, other methods of transmitting the UUID are also optional. As described herein other transmissions may be through the visual transmission, radio frequency transmission, blue tooth, or wifi. The transmission may be manual in that the user receives the information and then enters it into another device such as receiving an alphanumeric string and typing it into a user interface or in taking a camera image of a display.

On a second device, such as a mobile device, a user authenticates to their previously registered authenticator application and scans the login QR code (208). Although a QR code is shown and described, other methods of transmitting the UUID are also optional. As described herein other transmissions may be through the visual transmission, radio frequency transmission, blue tooth, or wifi. The transmission may be manual in that the user receives the information and then enters it into another device such as receiving an alphanumeric string and typing it into a user interface or in taking a camera image of a display.

In one embodiment, the authenticator application is previously registered to the authentication server and associated with a user.

The authentication application on the mobile device returns the login attempt UUID to the authentication server, signed with the private key of the user account of the authentication application (209).

The server validates the login attempt UUID and approves the login if the user has permission to access the service provider application (210).

The browser extension receives an approval state from the server and requests an identity payload for the login attempt (211).

The server validates the signed request from the extension and responds with an identity payload (212).

The extension receives the identity payload and redirects the browser to the service provider login endpoint (213).

The service provider validates the identity payload and logs the user in (214). In an alternate optional embodiment, the service provider is configured to receive identity assertions, described herein as an identity payload, using identity standards such as SAML or OpenID Connect.

In an alternate optional embodiment, a regular login is allowed to proceed on the authentication server login page if the extension is not installed.

In an alternate optional embodiment, if the extension is installed the extension is required to be used for login attempts.

In an alternate optional embodiment, the extension may be required to be used for logging into a single application, all applications for a customer, all applications for an account, or any combination thereof, where multiple applications may be associated with a customer and multiple customers may be associated with an account.

In an alternate optional embodiment, directly logging into an application through the mobile authenticator application may be allowed even if the extension is required for browser logins.

In an alternate optional embodiment, the authentication extension is pinned in the browser, meaning it is visible on the main browser screen at all times as an icon.

In an alternate optional embodiment, the authentication extension is not pinned but is still active and can be accessed and used for logins following the same methods described in the figure after it is accessed.

In an alternate optional embodiment, approved URLs are hardcoded into the authentication extension code.

In an alternate optional embodiment, approved URLs are retrieved from an authentication server.

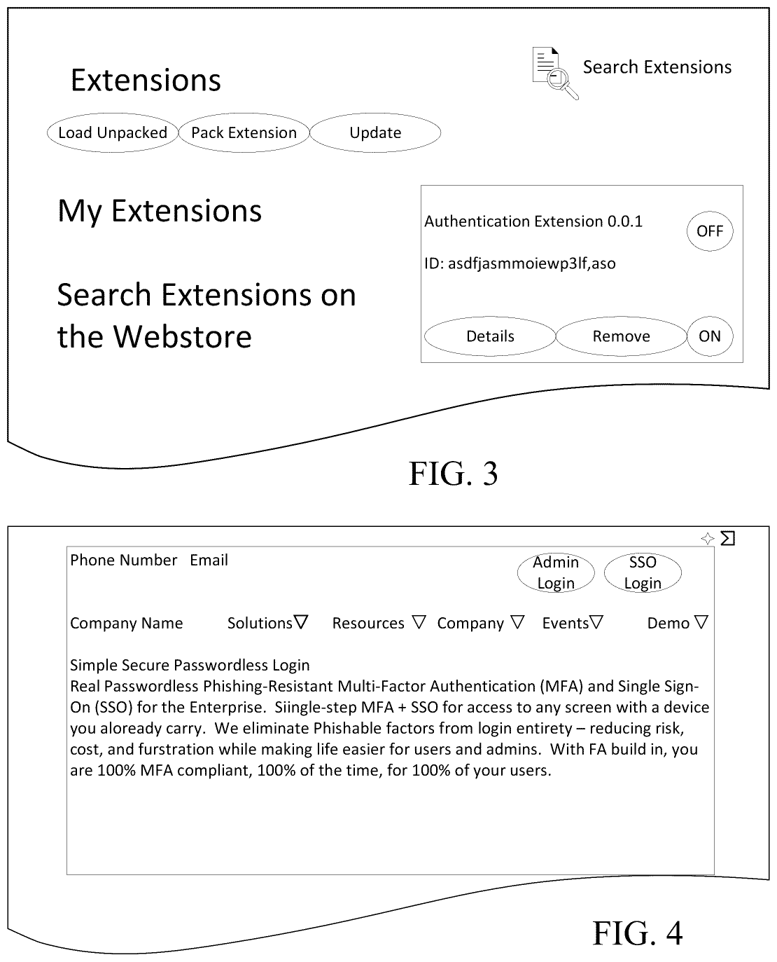

FIG. 3 illustrates an exemplary screen of a user device having a browser according to embodiments described herein when the browser extension is installed on a browser with the extension turned off. The extension may be turned on by clicking on the toggle.

FIG. 4 illustrates an exemplary user interface display of a browser showing a service provider webpage with two login buttons in the upper right corner. Clicking on one of the buttons redirects the browser to an authentication server login page. In one embodiment the authentication server is the service provider server. In another embodiment, the authentication server is separate from the service provider.

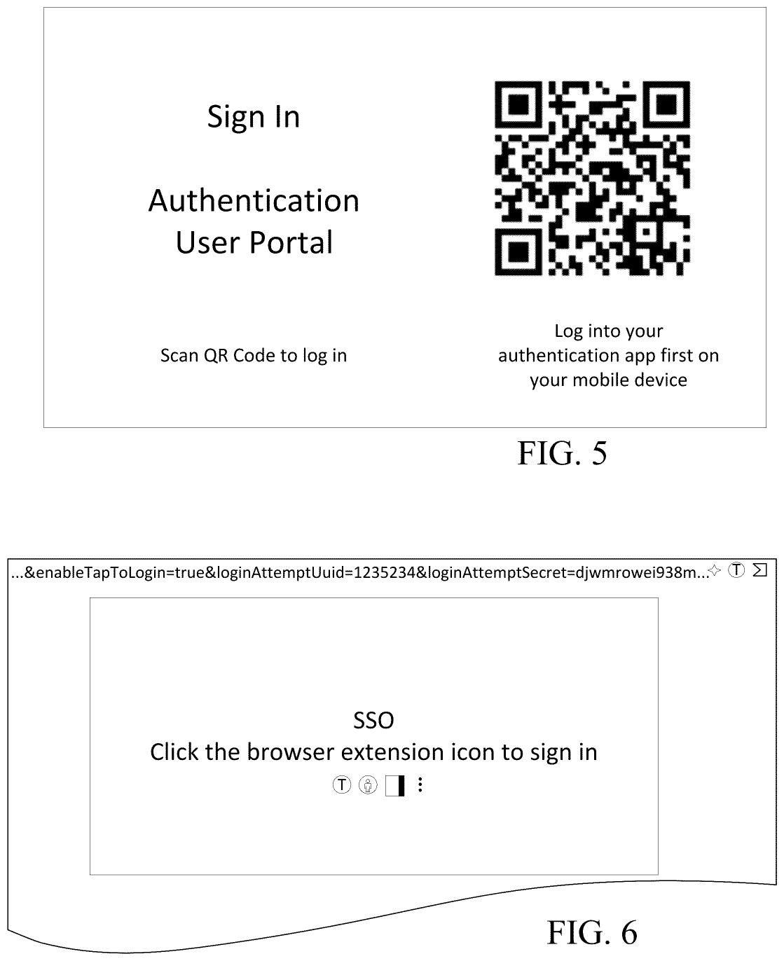

FIG. 5 illustrates an exemplary embodiment of a passwordless multi-factor login screen without an extension installed. In one embodiment, a user may scan the QR code with a previously registered mobile authenticator application and login if the user has permission to access the protected resource. In another embodiment the user may scan the QR code with a previously registered mobile authenticator application and be denied access to the protected resource if a requirement is set to only allow access through a login with a registered browser extension.

FIG. 6 illustrates an exemplary login screen when the extension is installed. Note the upper right corner shows the extension present and the logo of the pinned extension. In an exemplary embodiment the extension overrides the content of the regular login page to indicate that the extension must be used to log into the service.

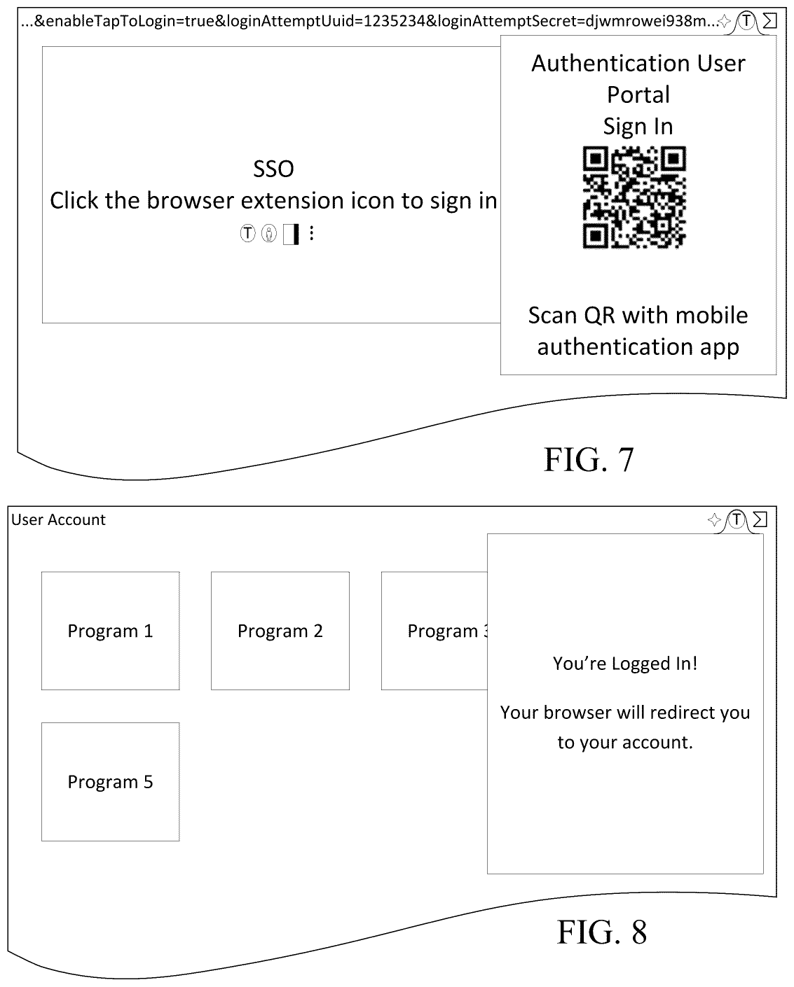

FIG. 7 illustrates an exemplary pop-up window of an extension displaying a QR code representing a login attempt which is scanned with an authenticator application using an account previously connected to the service being logged into. In one embodiment the QR code is a one-time code representing a login attempt.

FIG. 8 illustrates an exemplary successful login resulting in an updated pop-up indicating the user has logged in.

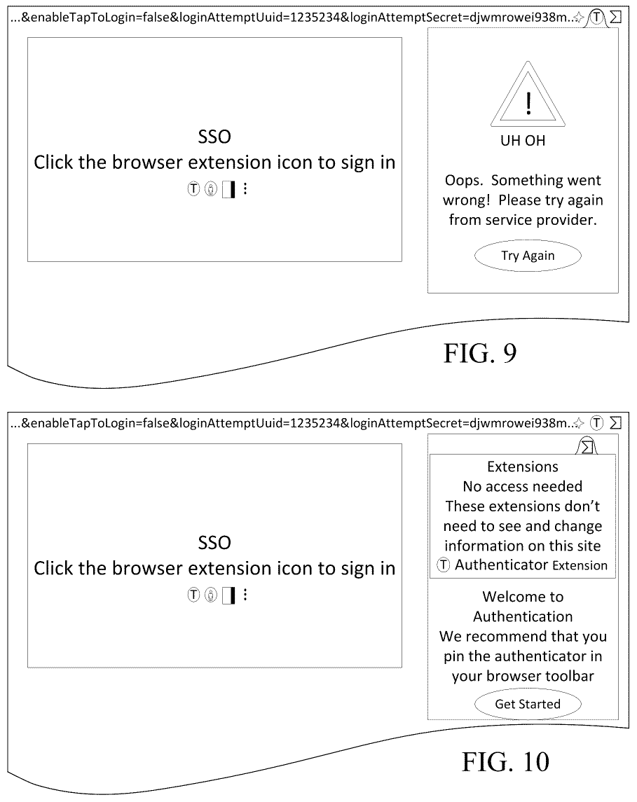

FIG. 9 illustrates an exemplary failed login attempt when scanning the QR code in the extension with a registered authenticator app account that is not registered to the browser extension.

FIG. 10 illustrates an exemplary welcome screen displayed in the extension popup after the extension is installed and before a user is registered.

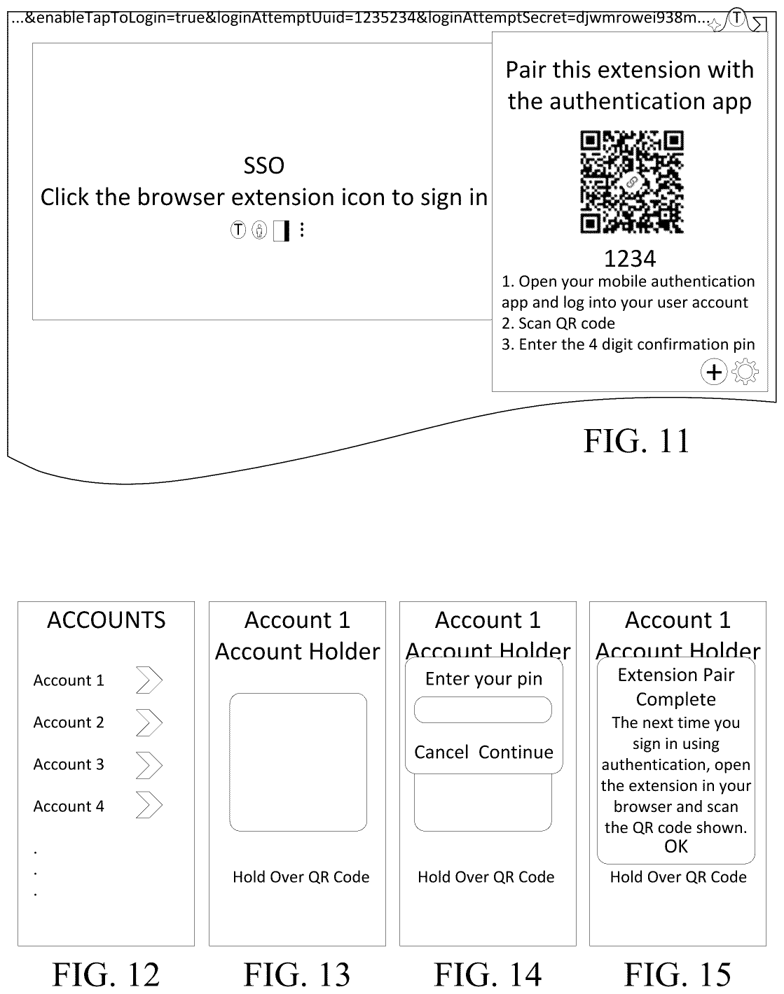

FIG. 11 illustrates an exemplary initial registration screen. In one embodiment, the extension creates a unique sessionId and public/private key pair for the registration process and sends them to an authentication server. The server then returns registration data that is displayed as a registration QR code and a four-digit PIN.

FIG. 11 also illustrates exemplary user account additions, where the gearbox in the extension popup is selected to enter advanced mode. Clicking the plus symbol generates a new registration code displayed as a QR code and a PIN. The user authenticates a selected account in the mobile authenticator application and scans the QR code. The user manually enters the PIN in a subsequent step to complete the registration process. In one embodiment the extension creates a unique sessionId and public/private key pair for each registered user.

FIG. 12 illustrates an exemplary mobile authenticator application screen listing user accounts previously registered to an authentication server. In one embodiment, a user selects the account they intend to register with the authentication extension. In another embodiment, a user selects the account they intend to use to log in to a resource through the registered extension.

FIG. 13 illustrates an exemplary QR code scanning screen of an authenticated mobile authenticator application. In one embodiment the screen is used to scan a registration QR code in an authentication extension to pair the selected user account to the extension. In another embodiment, the screen is used to scan a login QR code presented by the authentication extension to initiate a login attempt to a protected resource. In another embodiment, the QR code for registration is transferred via Bluetooth or other means of communication between the extension and the mobile authenticator application. In another embodiment, the QR code for login is transferred via Bluetooth or other means of communication between the extension and the mobile authenticator application.

FIG. 14 illustrates an exemplary screen displayed after scanning the registration QR code in the extension popup, where a field is presented for a user to manually enter the PIN displayed in the extension registration popup window. In another embodiment, the PIN is transferred via Bluetooth or other means of communication between the extension and the mobile authenticator application.

FIG. 15 illustrates an exemplary message indicating the successful pairing of the extension to the user account after the authentication server confirms that the registration code in the QR code and the PIN may be associated with the user account.

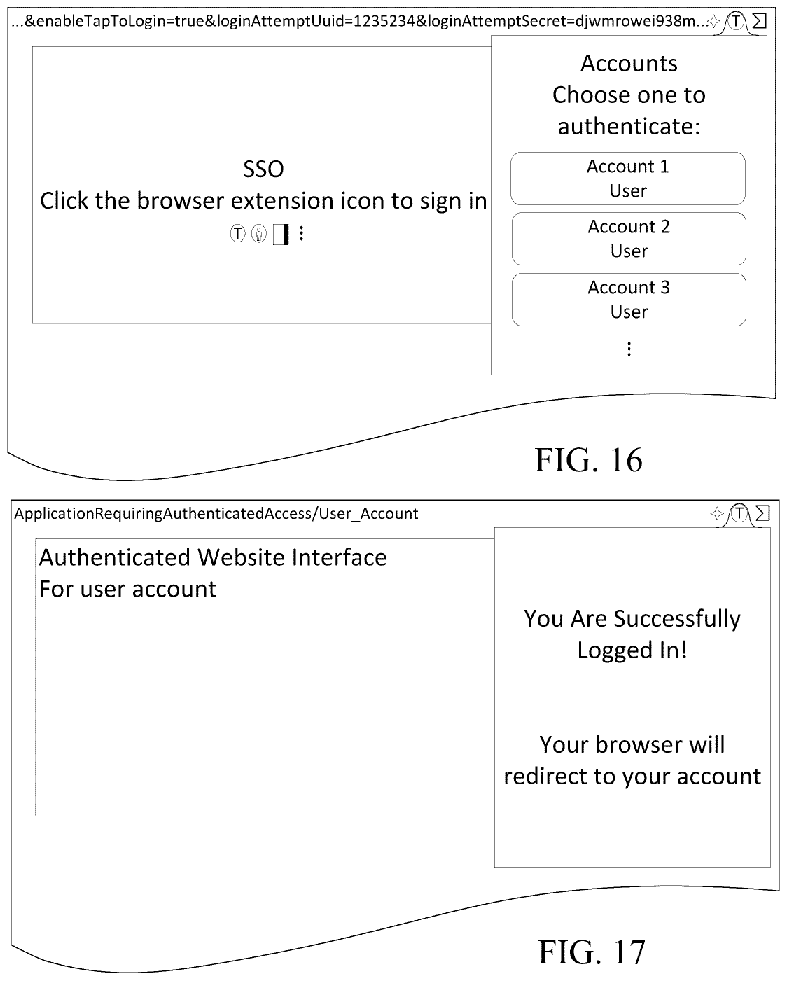

FIG. 16 illustrates an exemplary user interface of the browser that may be displayed before FIG. 11 to display an exemplary list of multiple registered accounts in the extension. In one embodiment, the user selects the account they intend to use for a login attempt. In another embodiment, there is a default account set that automatically begins the login process and the user may switch accounts by navigating to the account list screen and selecting a different account from the list.

After a user selects an account from a list of accounts in the extension, the display of FIG. 11 may be used but may or may not also indicate the selected account. When the account is selected, the extension uses a stored sessionId and private key associated with that user to request a login attempt from an authentication server. Scanning the QR code with the corresponding account on a mobile device authenticator application securely logs the user into the account if they have authorization to do so.

FIG. 17 illustrates an exemplary successful login by a user into an account selected from a list of accounts in the authentication extension.

In an optional embodiment, the registered browser extension may be used to register an agent on the first device. In an exemplary embodiment an agent may run in the background of a computing device and/or may be launched by the system. For example, an agent might be running when the device is powered on and is used to log into the machine.

In an optional embodiment, the registered browser extension may be used to authenticate a user to a desktop application. In an exemplary embodiment a desktop application may run when launched by a user.

In an optional embodiment, the registered browser extension may be used to deliver identity assurance in real-time for communication-based web applications, such as video conferencing systems.

In an optional embodiment, the registered browser extension may deliver identity assurance via the trusted browser session to a web application.

Exemplary embodiments of a secure location may include any combination of the applications for the registered browser extension including the access to an agent on the first device, authentication and access to a desktop application, real-time identity assurance for communication applications, identity to web applications.

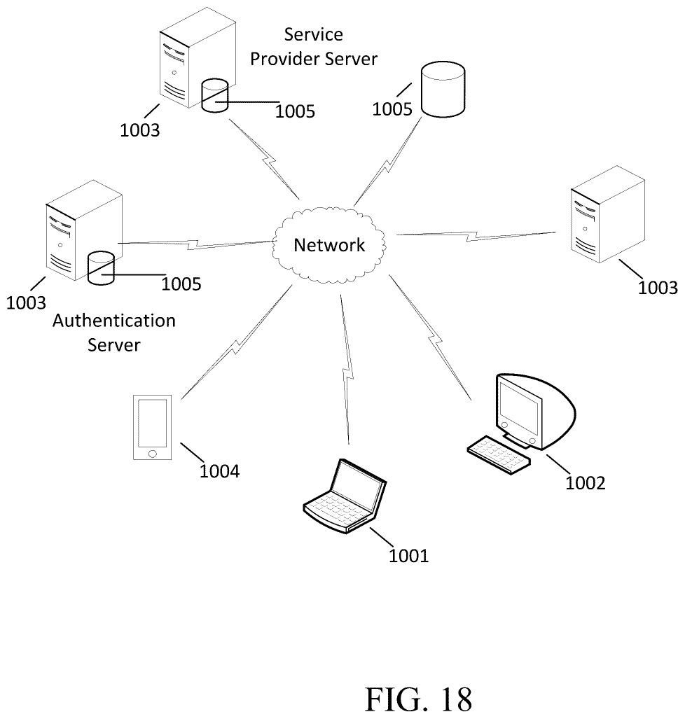

FIG. 18 illustrates exemplary system for authenticating a user as described herein. Exemplary embodiments of the system for authenticating a user described herein may include a computer, computers, electronic device, or electronic devices. As used herein, the term computer(s) and/or electronic device(s) are intended to be broadly interpreted to include a variety of systems and devices including personal computers 1002, laptop computers 1002, mainframe computers, servers 1003, mobile phone 1004, tablet, smart watch, smart displays, televisions, and the like. A computer can include, for example, processors, memory components for storing data (e.g., read only memory (ROM) and/or random access memory (RAM), other storage devices, various input/output communication devices and/or modules for network interface capabilities, etc. For example, the system may include a processing unit including a memory, a processor, an analog-to-digital converter (A/D), a plurality of software routines that may be stored as non-transitory, machine readable instruction on the memory and executed by the processor to perform the processes described herein. The processing unit may be based on a variety of commercially available platforms such as a personal computer, a workstation a laptop, a tablet, a mobile electronic device, or may be based on a custom platform that uses application-specific integrated circuits (ASICs) and other custom circuitry to carry out the processes described herein. Additionally, the processing unit may be coupled to one or more input/output (I/O) devices that enable a user to interface to the system. By way of example only, the processing unit may receive user inputs via a keyboard, touchscreen, mouse, scanner, button, or any other data input device and may provide graphical displays to the user via a display unit, which may be, for example, a conventional video monitor. The system may also include one or more large area networks, and/or local networks for communicating data from one or more different components of the system. The one or more electronic devices may therefore input a user interface for displaying information to a user and/or one or more input devices for receiving information from a user. The system may receive and/or display the information after communication to or from a remote server 1003 or database 1005.

Exemplary embodiments of the systems and methods described herein include an authentication method where an authentication browser extension registration is performed using an authenticated mobile device to scan a QR code of a browser extension and a manually entered PIN to associate the user with an active extension session.

The method and/or system may have a unique session identifier and public/private key pair are created by a browser authentication extension, sent to an authentication server, and associated with a user previously registered on the authentication server upon successful completion of the registration process.

The method and/or system may have an administrator approval of the user registering to the extension and granular controls, such as browser type may be enforced prior to the extension being registered.

The method and/or system may have multiple users registered to the authentication extension.

Exemplary methods and systems described herein may include an authentication browser extension is used to log into a service provider, where the browser extension has a previously registered and valid sessionId associated with a user, the user using an authenticator application to scan a QR code presented by the extension, the authenticator application sending the contents of the QR to the authentication server, the server validating the login request, the extension receiving an approved state while polling the authentication server, the extension requesting an identity payload from the authentication server, the extension receiving the identity payload and redirecting to the service provider and providing the identity payload; and the service provider receiving the identity payload and logging the user into the service.

The method and/or system may have a regular login is allowed if the extension is not installed.

The method and/or system may have a requirement where the extension is installed, the extension is use and the extension is required for a login.

The method and/or system may have the extension required to be used for logging into a single application, all applications for a customer, all applications for an account, or any combination thereof, where multiple applications may be associated with a customer and multiple customers may be associated with an account.

The method and/or system may have directly logging into an application through the mobile authenticator application may be allowed even if the extension is required for browser logins.

The method and/or system may have one of multiple registered users may be selected from a list in the extension to initiate a login attempt.

The method and/or system may have a login that is only permitted if the login page is an approved URL.

Exemplary embodiments described herein may use a QR code to provide data between device through the use of a camera and decoding of the QR. Exemplary embodiments are not so limited. Other forms of data transfer may occur, such as data transfer through Wi-Fi or near field communication (NFC), Bluetooth or other protocol, inferred (IR) transmitter/receivers may also be used, and/or other visual detection/codes (such as bar codes, images, text etc.). Exemplary embodiments may also or alternatively use a user interface such as input and output devices, including, without limitation, screens, touch screens, keyboards, numbers, buttons, mount clicks, drop down, button selection, etc. in order to have a user obtain data from a first device and enter it into a second device (whether the first and second devices are the same or different). Therefore, embodiments described herein in which PIN or QR codes are use, these embodiments may also or alternatively include any combination of other data transfer.

Compared with prior art, the present invention provides an authentication method using a browser extension on a browser of a first device and a second electronic device and has the following beneficial effects: It offers a high level of security by combining the capabilities of a browser extension and a mobile device, effectively addressing various threats such as phishing attacks, keyloggers, and password brute-forcing; It enables seamless integration across multiple websites and applications, eliminating the need for users to manage multiple authentication apps and reducing the risk of credential exposure across different platforms; It enhances user convenience by simplifying the authentication process through the use of QR codes, PINs, and mobile device integration, while maintaining robust security principles; It provides dynamic security measures that change regularly, such as unique session identifiers and public/private key pairs, mitigating the risk of potential attacks over time; It reduces the need for users to memorize or track various login credentials for different secure sites; It allows for granular controls and administrator approval during the registration process, ensuring proper oversight and enforcement of security policies; It supports multiple registered users for the authentication extension, catering to various use cases and scenarios; It offers flexibility in authentication methods, allowing for regular logins if the extension is not installed, while enforcing the use of the extension for enhanced security when required; It enables selective enforcement of the extension-based authentication method for specific applications, customers, or accounts, providing tailored security configurations based on organizational needs; It permits direct logins through the mobile authenticator application, even when the extension is required for browser-based logins, offering additional convenience and flexibility.

The purpose of the invention is to overcome the drawbacks in the existing technology and provide a method for secure and convenient authentication using a browser extension and mobile device, which includes: performing authentication browser extension registration; creating a unique session identifier and public/private key pair; determine if administrator approval and granular controls are required and/or if met; enabling authentication using the browser extension and mobile device.

The step of performing authentication browser extension registration may include any combination of: using an authenticated mobile device to scan a quick response (QR) code displayed by the browser extension; manually entering a unique identifier such as a PIN on the mobile device to associate the user with an active extension session; allowing multiple users to register with the authentication extension.

The step of creating a unique session identifier and public/private key pair may include any combination of: generating a unique session identifier and public/private key pair by the browser authentication extension; sending the unique session identifier and the public key of the public/private key pair to an authentication server; associating the unique session identifier and public key with a previously registered user upon successful completion of the registration process.

The step of determining if administrator approval and granular controls are required and/or if met may include any combination of: initiating a login attempt to a service provider using the browser extension, where the extension has a previously registered and valid sessionId associated with the user; the user using an authenticator application on their mobile device to scan a QR code presented by the extension; the authenticator application sending the contents of the QR code to the authentication server; the authentication server validating the login request; the extension receiving an approved state while polling the authentication server; the extension requesting an identity payload from the authentication server; the extension receiving the identity payload and redirecting to the service provider, providing the identity payload; the service provider receiving the identity payload and logging the user into the service.

Optional embodiments of the method may further include any combination of additional steps, such as, for example, any combination of: allowing a regular login if the extension is not installed; requiring the use of the extension for a login when the extension is installed; enabling the extension to be required for logging into a single application, all applications for a customer, all applications for an account, or any combination thereof, where multiple applications may be associated with a customer and multiple customers may be associated with an account; permitting direct login to an application through the mobile authenticator application, even if the extension is required for browser logins; allowing one of multiple registered users to be selected from a list in the extension to initiate a login attempt; permitting a login only if the login page is an approved URL.

Exemplary embodiments described herein may include a browser extension and mobile device authentication method for secure user access.

In an exemplary first embodiment, the authentication method using a browser extension and mobile device comprises the following steps: Step 1, performing authentication browser extension registration; Step 1a, using an authenticated mobile device to scan a QR code displayed by the browser extension, wherein the QR code contains information for associating the user with an active extension session; Step 1b, manually entering a personal identification number (PIN) on the mobile device, to further associate the user with the active extension session; Step 1c, allowing multiple users to register with the authentication extension. Step 2, creating a unique session identifier and public/private key pair; Step 2a, generating a unique session identifier by the browser authentication extension; Step 2b, sending the unique session identifier and public key to an authentication server; Step 2c, associating the unique session identifier and public/private key pair with a previously registered user upon successful completion of the registration process. Step 3, enabling authentication using the browser extension and mobile device; Step 3a, initiating a login attempt to a service provider by a user through the browser extension, wherein the extension has a previously registered and valid sessionId associated with the user; Step 3b, the user using an authenticator application installed on their mobile device to scan a QR code presented by the extension, the QR code containing information for validating the login request; Step 3c, the authenticator application sending the contents of the scanned QR code to the authentication server; Step 3d, the authentication server validating the login request by verifying the received QR code information against the previously registered sessionId and public key associated with the user; Step 3e, the extension receiving an approved state from the authentication server while periodically polling the server; Step 3f, upon receiving the approved state, the extension requesting an identity payload from the authentication server; Step 3g, the extension receiving the identity payload and redirecting to the service provider, providing the identity payload; Step 3 h, the service provider receiving the identity payload, verifying the digital signature using the user's public key, and upon successful verification, logging the user into the service. In an optional embodiment, the identity payload may include the user's personal information and a digital signature generated using the user's private key.

In an exemplary first embodiment, the authentication method using a browser extension and mobile device comprises the following steps: Step 1, performing authentication browser extension registration; Step 1a, using an authenticated mobile device to scan a QR code displayed by the browser extension, wherein the QR code contains information for associating the user with an active extension session; Step 1b, manually entering a personal identification number (PIN) on the mobile device, the PIN ranging from 4 to 8 digits, to further associate the user with the active extension session; Step 1c, allowing multiple users, ranging from 2 to 10 users, to register with the authentication extension. Step 2, creating a unique session identifier and public/private key pair; Step 2a, generating a unique session identifier comprising a 32-character alphanumeric string and a 2048-bit RSA public/private key pair by the browser authentication extension; Step 2b, sending the unique session identifier and public key to an authentication server over a secure HTTPS connection; Step 2c, associating the unique session identifier and public/private key pair with a previously registered user upon successful completion of the registration process, wherein the user was previously registered on the authentication server by providing personal information such as name, date of birth, and government-issued identification number. Step 3, judging if administrator approval and granular controls are required; If administrator approval is required, returning to Step 1 and awaiting approval from an authorized administrator before proceeding, wherein the administrator can approve or deny the registration based on factors such as the user's identity, the browser type, and the device used for registration; If granular controls are required, enforcing specific controls such as limiting the registration to a particular browser type (e.g., Google Chrome, Mozilla Firefox) or device type (e.g., mobile, desktop) before proceeding; If neither administrator approval nor granular controls are required, proceeding to Step 4. Step 4, enabling authentication using the browser extension and mobile device; Step 4a, initiating a login attempt to a service provider by a user through the browser extension, wherein the extension has a previously registered and valid sessionId associated with the user; Step 4b, the user using an authenticator application installed on their mobile device to scan a QR code presented by the extension, the QR code containing information for validating the login request; Step 4c, the authenticator application sending the contents of the scanned QR code to the authentication server over a secure HTTPS connection; Step 4d, the authentication server validating the login request by verifying the received QR code information against the previously registered sessionId and public key associated with the user; Step 4c, the extension receiving an approved state from the authentication server while periodically polling the server at intervals of 2 to 5 seconds; Step 4f, upon receiving the approved state, the extension requesting an identity payload from the authentication server, the identity payload comprising the user's personal information and a digital signature generated using the user's private key; Step 4g, the extension receiving the identity payload and redirecting to the service provider, providing the identity payload; Step 4h, the service provider receiving the identity payload, verifying the digital signature using the user's public key, and upon successful verification, logging the user into the service.

The method further includes any combination of the additional features: allowing a regular login if the extension is not installed on the user's browser; requiring the use of the extension for a login when the extension is installed on the user's browser; enabling the extension to be required for logging into a single application, all applications for a customer, all applications for an account, or any combination thereof, where multiple applications may be associated with a customer and multiple customers may be associated with an account; permitting direct login to an application through the mobile authenticator application, even if the extension is required for browser logins; allowing one of multiple registered users to be selected from a list in the extension to initiate a login attempt; permitting a login only if the login page is an approved URL, wherein the approved URLs are maintained in a whitelist on the authentication server.

Another embodiment of the present disclosure includes an authentication method using a browser extension and mobile device comprises the following steps: Step 1, performing authentication browser extension registration; Step 1a, using an authenticated mobile device to transfer a unique registration code from the browser to the mobile device; Step 1b, transferring a personal identification number (PIN) on the mobile device to associate the user with an active extension session. Step 2, creating a unique session identifier and public/private key pair; Step 2a, generating a unique session identifier by the browser authentication extension; Step 2b, sending the unique session identifier and public key to an authentication server; Step 2c, associating the unique session identifier and public/private key pair with a previously registered user upon successful completion of the registration process. Step 3, judging if administrator approval and granular controls are required; If administrator approval is required, returning to Step 1 and awaiting approval from an authorized administrator before proceeding, wherein the administrator can approve or deny the registration based on factors such as the user's identity, the browser type, the device used for registration, and the user's risk profile; If granular controls are required, enforcing specific controls such as limiting the registration to a particular browser version (e.g., Google Chrome version 80 or later) or device operating system (e.g., iOS 13 or later) before proceeding; If neither administrator approval nor granular controls are required, proceeding to Step 4. Step 4, enabling authentication using the browser extension and mobile device; Step 4a, initiating a login attempt to a service provider by a user through the browser extension, wherein the extension has a previously registered and valid sessionId associated with the user; Step 4b, the user using an authenticator application installed on their mobile device to obtain a one-time password (OTP) for validating the login request; Step 4c, the authenticator application sending the OTP to the authentication server; Step 4d, the authentication server validating the login request by verifying the received OTP against the previously registered sessionId and public key associated with the user; Step 4e, the extension receiving an approved state from the authentication server while periodically polling the server; Step 4f, upon receiving the approved state, the extension requesting an identity payload from the authentication server; Step 4g, the extension receiving the identity payload and redirecting to the service provider, providing the identity payload; Step 4 h, the service provider receiving the identity payload, verifying the digital signature using the user's public key, and upon successful verification, logging the user into the service.

The identity payload may include the user's personal information, biometric data, and a digital signature generated using the user's private key.

Another embodiment of the present disclosure includes an authentication method using a browser extension and mobile device comprises the following steps: Step 1, performing authentication browser extension registration; Step 1a, using an authenticated mobile device to scan a QR code displayed by the browser extension, wherein the QR code contains a unique registration code; Step 1b, manually entering a 6-digit personal identification number (PIN) on the mobile device to associate the user with an active extension session; Step 1c, allowing up to 5 users to register with the authentication extension. Step 2, creating a unique session identifier and public/private key pair; Step 2a, generating a unique session identifier comprising a 24-character alphanumeric string and a 4096-bit ECC public/private key pair by the browser authentication extension; Step 2b, sending the unique session identifier and public key to an authentication server over a secure WebSocket connection; Step 2c, associating the unique session identifier and public/private key pair with a previously registered user upon successful completion of the registration process, wherein the user was previously registered on the authentication server by providing personal information such as name, address, and government-issued identification number, as well as biometric data such as fingerprint or facial scan. Step 3, judging if administrator approval and granular controls are required; If administrator approval is required, returning to Step 1 and awaiting approval from an authorized administrator before proceeding, wherein the administrator can approve or deny the registration based on factors such as the user's identity, the browser type, the device used for registration, and the user's risk profile; If granular controls are required, enforcing specific controls such as limiting the registration to a particular browser version (e.g., Google Chrome version 80 or later) or device operating system (e.g., iOS 13 or later) before proceeding; If neither administrator approval nor granular controls are required, proceeding to Step 4. Step 4, enabling authentication using the browser extension and mobile device; Step 4a, initiating a login attempt to a service provider by a user through the browser extension, wherein the extension has a previously registered and valid sessionId associated with the user; Step 4b, the user using an authenticator application installed on their mobile device to scan a QR code presented by the extension, the QR code containing a one-time password (OTP) for validating the login request; Step 4c, the authenticator application sending the scanned OTP to the authentication server over a secure HTTPS connection; Step 4d, the authentication server validating the login request by verifying the received OTP against the previously registered sessionId and public key associated with the user; Step 4e, the extension receiving an approved state from the authentication server while periodically polling the server at intervals of 3 seconds; Step 4f, upon receiving the approved state, the extension requesting an identity payload from the authentication server, the identity payload comprising the user's personal information, biometric data, and a digital signature generated using the user's private key; Step 4g, the extension receiving the identity payload and redirecting to the service provider, providing the identity payload; Step 4 h, the service provider receiving the identity payload, verifying the digital signature using the user's public key, and upon successful verification, logging the user into the service.

The method further also include any combination of the following steps: allowing a regular login if the extension is not installed on the user's browser; requiring the use of the extension for a login when the extension is installed on the user's browser; enabling the extension to be required for logging into all applications associated with a customer or an account, where multiple applications may be associated with a customer and multiple customers may be associated with an account; permitting direct login to an application through the mobile authenticator application, even if the extension is required for browser logins; allowing one of multiple registered users to be selected from a list in the extension to initiate a login attempt; permitting a login only if the login page is an approved URL, wherein the approved URLs are maintained in a whitelist on the authentication server and updated periodically.

Another embodiment of the invention described herein includes an authentication method to remotely access a secure network location including registering a browser extension on a browser of a first device of a user with an authentication server and using the browser extension to log into a secure location through the browser using a second device of the user.

The step of registering a browser extension on a browser of a first device of a user with an authentication server may include creating a public/private key pair, storing the private key of the public/private key pair locally at the first device, and storing the public key of the public/private key pair at the authentication server.

The step of using the browser extension to log into a secure location through the browser may include sending a login request from the browser extension to the authentication server using the private key, authenticating the login request at the authentication server using the public key, sending a unique login identifier from the authentication server to the browser extension, communicating the login identifier from the browser extension on the first device to the second device, communicating the login identifier from the second device to the authentication server, authenticating the login identifier with the authentication server, login approval sent from the authentication server to the browser extension when the login identifier is authenticated by the authentication server, identity payload sent from authentication server to browser extension, and logging in the user to the secure location with the browser extension using the identity payload.

The authentication method including registering the browser extension on the browser of the first device may include exchanging a unique identifier from the browser extension to a second device of the user, sending the unique identifier from the second device to an authentication server, authenticating the unique identifier with the authentication server, and registering the browser extension on the browser of the first device with the user after the authentication server authenticates the unique identifier.

The authentication method including exchanging the unique identifier from the browser extension to the second device of the user may include displaying a quick response (QR) code on a display of the browser, the QR code related to the unique identifier, receiving an image of the QR code on the second device, and extracting the unique identifier from the QR code.

The authentication method including registering the browser extension may further include making a registration request with the browser extension to the authentication server and communicating the public key of the private/public key pair from the browser extension to the authentication server with the registration request.

The authentication method including registering the browser extension may further include sending a pending extension session identifier and the unique login identifier from the authentication server to the browser extension, and the public key is associated with the pending extension session.

The authentication method including the communicating the login identifier from the browser extension on the first device to the second device may further include displaying the login identifier on a display of the browser with the browser extension and entering the login identifier into a user interface of the second device.

The authentication method including using the browser extension to log into the secure location through the browser further may further include communicating the extension session identifier from the browser extension to the second device and sending the extension session identifier to the authentication server with the second device.

The authentication method including communicating the extension session identifier from the browser extension to the second device further includes displaying a quick response (QR) code related to the extension session identifier on a display of the browser and receiving an image of the QR code on the second device and extracting the extension session identifier from the QR code.

The authentication method including registering the browser extension may further include confirming that preselected controls are met before registering the browser.

The authentication method including the preselected controls may include any combination of receiving an administer approval or confirming a browser type of the browser.

The authentication method may further include registering multiple user accounts to the browser extension and selecting a single user account before using the browser extension to log into the secure location through the browser.

The authentication method may further include determining whether a browser extension is installed on a browser and permitting a login to the secure location using a user credential and not using an identity payload received from the authentication server.

The authentication method may further include determining whether a browser extension is installed on the browser and requiring login through the browser extension if the browser extension is installed.

The authentication method may require the browser extension to be used for logging into a single application, all applications for a customer, all applications for an account, or any combination thereof, where multiple applications are associated with a customer and multiple customers are associated with an account.

The authentication method may further include permitting direct log in to the secure location with user credentials from an application on the second device even when the browser extension is required for log in to the secure location through a browser.

The authentication method may further include navigating to a login page to access the secure location, wherein a log in to the secure location is only initiate when the login page comprises a domain of the universal resource locator (URL) that is approved.

Exemplary embodiments of the system described herein can be based in software and/or hardware. While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

In addition, the terms “unit”, “-er”, “-or”, and “module” described in the specification mean units for processing at least one function and operation, and can be implemented by hardware components or software components and combinations thereof.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

An “electronic device” or a “computing device” refers to a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

The terms “memory,” “memory device,” “computer-readable storage medium,” “data store,” “data storage facility” and the like each refer to a non-transitory device on which computer-readable data, programming instructions or both are stored. Except where specifically stated otherwise, the terms “memory,” “memory device,” “computer-readable storage medium,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The terms “instructions” and “programs” may be used interchangeably herein. The instructions may be stored in object code format for direct processing by the processor, or in any other computing device language, including scripts or collections of independent source code modules that are interpreted on demand or compiled in advance. Functions, methods, and routines of the instructions are explained in more detail below. The instructions may be any set of instructions to be executed directly (such as machine code) or indirectly (such as scripts) by the processor. For example, the instructions may be stored as computing device code on the computing device-readable medium.

The term “data” may be retrieved, stored or modified by processors in accordance with a set of instructions. For instance, although the claimed subject matter is not limited by any particular data structure, the data may be stored in computing device registers, in a relational database as a table having a plurality of different fields and records, XML documents or flat files. The data may also be formatted in any computing device-readable format.

The term “module” refers to a set of computer-readable programming instructions, as executed by a processor, that cause the processor to perform one or more specified function(s).

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute these modules to perform one or more processes that are described further below.

Further, the control logic of the present disclosure may be embodied as non-transitory computer readable media on a computer readable medium containing executable programming instructions executed by a processor, controller, or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network-coupled computer systems so that the computer readable media may be stored and executed in a distributed fashion such as, e.g., by a telematics server or a Controller Area Network (CAN).

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

The invention claimed is:

1. An authentication method to remotely access a secure network location comprising:
registering a browser extension on a browser of a first device of a user with an authentication server by:
creating a public/private key pair,
storing the private key of the public/private key pair locally at the first device, and
storing the public key of the public/private key pair at the authentication server;
using the browser extension to log into a secure location through the browser by:
sending a login request from the browser extension to the authentication server using the private key,
authenticating the login request at the authentication server using the public key,
sending a unique login identifier from the authentication server to the browser extension;
communicating the login identifier from the browser extension on the first device to the second device;
communicating the login identifier from the second device to the authentication server;
authenticating the login identifier with the authentication server;
login approval sent from the authentication server to the browser extension when the login identifier is authenticated by the authentication server;
identity payload sent from authentication server to browser extension; and
logging in the user to the secure location with the browser extension using the identity payload.

2. The authentication method of claim 1, wherein registering the browser extension on the browser of the first device comprises exchanging a unique identifier from the browser extension to a second device of the user; sending the unique identifier from the second device to an authentication server; authenticating the unique identifier with the authentication server; registering the browser extension on the browser of the first device with the user after the authentication server authenticates the unique identifier.

3. The authentication method of claim 2, wherein exchanging the unique identifier from the browser extension to the second device of the user comprises, displaying a quick response (QR) code on a display of the browser, the QR code related to the unique identifier, receiving an image of the QR code on the second device, and extracting the unique identifier from the QR code.

4. The authentication method of claim 2, wherein registering the browser extension further comprises making a registration request with the browser extension to the authentication server and communicating the public key of the private/public key pair from the browser extension to the authentication server with the registration request.

5. The authentication method of claim 4, wherein registering the browser extension further comprises sending a pending extension session identifier and the unique login identifier from the authentication server to the browser extension, and the public key is associated with the pending extension session.

6. The authentication method of claim 5, wherein the communicating the login identifier from the browser extension on the first device to the second device comprises displaying the login identifier on a display of the browser with the browser extension and entering the login identifier into a user interface of the second device.

7. The authentication method of claim 5, wherein using the browser extension to log into the secure location through the browser further comprising communicating the extension session identifier from the browser extension to the second device and sending the extension session identifier to the authentication server with the second device.

8. The authentication method of claim 5, wherein communicating the extension session identifier from the browser extension to the second device comprises displaying a quick response (QR) code related to the extension session identifier on a display of the browser and receiving an image of the QR code on the second device and extracting the extension session identifier from the QR code.

9. The authentication method of claim 1, wherein registering the browser extension further comprises confirming preselected controls are met before registering the browser.

10. The authentication method of claim 9, wherein the preselected controls include any combination of receiving an administer approval or confirming a browser type of the browser.

11. The authentication method of claim 1, further comprising registering multiple user accounts to the browser extension and selecting a single user account before using the browser extension to log into the secure location through the browser.

12. The authentication method of claim 1, further comprising determining whether a browser extension is installed on a browser and permitting a login to the secure location using a user credential and not using an identity payload received from the authentication server.

13. The authentication method of claim 1, further comprising determining whether a browser extension is installed on the browser and requiring login through the browser extension if the browser extension is installed.

14. The authentication method of claim 13, wherein the browser extension is required to be used for logging into a single application, all applications for a customer, all applications for an account, or any combination thereof, where multiple applications are associated with a customer and multiple customers are associated with an account.

15. The authentication method of claim 14, further comprising permitting direct log in to the secure location with user credentials from an application on the second device even when the browser extension is required for log in to the secure location through a browser.

16. The authentication method of claim 15, further comprising navigating to a login page to access the secure location, wherein a log in to the secure location is only initiate when the login page comprises a domain of the universal resource locator (URL) that is approved.
